(19) United States
(12) Patent Application Publication
(10) Pub. No.: US 2019/0234829 A1
(43) Pub. Date: Aug. 1, 2019

(54) MEASURING A TORSION ANGLE OF A ROTOR BLADE

(71) Applicant: Wobben Properties GmbH, Aurich (DE)

(72) Inventors: Dennis DIETZ, Bremen (DE); Chris KUHNKE, Aurich (DE)

(21) Appl. No.: 16/316,561

(22) PCT Filed: Jul. 5, 2017
(86) PCT No.: PCT/EP2017/066764

§ 371 Date: Jan. 9, 2019

(30) Foreign Application Priority Data
Jul. 11, 2016 (DE) 10 2016 112 633.0

(51) Int. Cl. G01M 5/00; G01D 5/26; F03D 17/00; F03D 80/50

(52) U.S. Cl. CPC G01M 5/0041; G01D 5/268; F05B 2230/60; F03D 80/50; F05B 2230/80; F03D 17/00

(57) ABSTRACT

A measuring system for determining a torsion of a rotor blade, comprising a reference shaft to be arranged in the rotor blade in the longitudinal direction of the blade, at least one support for the reference shaft, for freely bearing the reference shaft in the rotor blade, so that the rotor blade can twist freely about the reference shaft, so that the reference shaft does not twist when there is twisting of the rotor blade, at least one rotary sensor, arranged on the reference shaft, for detecting a twisting of the rotor blade about the reference shaft in the region of the rotary sensor, the rotary sensor outputting a rotational angle describing the twisting of the rotor blade in relation to the reference shaft, or some other corresponding variable. A method for determining a torsion of a rotor blade, a corresponding rotor blade, a method for arranging a measuring system in a rotor blade and a corresponding wind power installation with a rotor blade and also or alternatively a measuring system.

### BACKGROUND

### Technical Field

The invention relates to a measuring system and to a method for determining a torsion of a rotor blade. The invention also relates to a corresponding rotor blade and to a method for arranging a measuring system according to the invention in the rotor blade and in addition to a corresponding wind power installation.

### Description of the Related Art

During the operation of a wind power installation, the rotor blades rotate about a substantially horizontal rotor axis. Because of aerodynamic effects that occur on the rotor blades during the rotation, the rotor blades can twist or undergo torsion. In this case, for example, the orientation of a profile chord in the region of the blade tip is at an angle with respect to the orientation of a profile chord in the region of the blade root. This angle is referred to here as the torsion angle and it depends on the positions of the profile chords along the rotor blade.

At least one known method for determining the torsion angle is based on the use of a camera system. For this, a camera which is directed at the wind power installation is set up in an area in front of the wind power installation. The camera detects the position of the rotor blades, for example by way of markings provided on the rotor blades, and from this can infer the orientation of the profile chords or a deformation of the rotor blade. Then, the torsion angle of the rotor blade can be determined from the orientation of the profile chords in relation to one another. A disadvantage of this system is that it can only be used at restricted times, to be specific when the rotor has a specific orientation in relation to the camera. Furthermore, such a system also involves great preparational effort, or the operator of the wind power installation is dependent on external service providers.

Other known solutions for determining the torsion angle provide fiber-optic cables in the rotor blade. The fiber-optic cable is in this case adhesively attached to the material of the rotor blade. The deformation or torsion of the rotor blade, and consequently the deformation or torsion of the cable, brings about the effect of a polarization of the light conducted through the fiber-optic cable. By means of an evaluation unit, the torsion angle can be inferred from the polarization. However, it has been found that with such a system there is a great dependence on the bending behavior of the rotor blade, as a result of which erroneous torsion angles are determined when there is simultaneous bending and torsion of the rotor blade. In addition, a cable adhesively attached to the rotor blade is influenced by the thermal expansion of the rotor blade. The measurement consequently does not take place temperature-independently.

The German Patent and Trademark Office has searched the following prior art in the priority application for the present PCT application: DE 10 2014 117 914 A1 and US 2013/0093 879 A1.

### BRIEF SUMMARY

Provided is a measuring system comprises a reference shaft to be arranged in the rotor blade and at least one rotary sensor arranged on the reference shaft. The reference shaft is supported in such a way that the rotor blade can twist freely about the reference shaft and in such a way that the reference shaft itself does not twist when there is twisting of the rotor blade. So if the rotor blade twists during operation, a differential angle occurs between the twisted rotor blade and the non-twisted reference shaft. The rotary sensor arranged on the reference shaft detects the torsion or the twisting of the rotor blade about the reference shaft in the region of the rotary sensor and outputs a rotational angle describing the twisting of the rotor blade in relation to the reference shaft, or some other corresponding variable.

Instead of the rotational angle, an electrical voltage or a value normalized to a maximum rotational angle that is proportional to the rotational angle may for example be output as a corresponding variable.

Therefore, a measuring system in which the rotor blade twists about a rigid reference shaft is proposed. By comparison with the reference shaft, the twisting of the rotor blade can in this way be quantitatively detected at each location of the rotor blade at which a rotary sensor is arranged.

With such a measuring system, the torsion angle can be continuously detected, since the rotary sensor continuously detects a torsion angle of the rotor blade in relation to the reference shaft. Such a measuring system is also independent of the alignment of the rotor with an external system, since the measuring system is integrated in the rotor blade.

One embodiment of the measuring system provides that the reference shaft is formed as a hollow shaft. Hollow shafts allow a lightweight construction and nevertheless have a great stiffness, in particular also a great torsional stiffness. If the reference shaft is formed as a hollow shaft, the measuring system only increases the weight of the rotor blade insignificantly. The measuring system consequently scarcely influences the properties of the rotor blade.

A further embodiment of the measuring system provides supporting means in order to arrange the reference shaft along a leading edge web of the rotor blade. The leading edge web of a rotor blade runs substantially over the entire length of the rotor blade in the region of the leading edge of the rotor blade. The leading edge web represents a connection in this front region between an upper side and an underside of the rotor blade and stiffens the rotor blade, in order that the rotor blade withstands the wind loads to which it is exposed. In particular, a rotor blade twists substantially about the leading edge web. The leading edge web is consequently very well suited for determining the torsion angle of the rotor blade, since the distance from the torsion axis, that is to say the axis about which the rotor blade twists, is minimal here and no or only minor deviations occur. The leading edge web can extend substantially through the entire rotor blade, and is consequently very well suited for receiving the reference shaft and guiding it through the entire blade.

In a further embodiment of the measuring system, a rotationally fixed shaft seat is provided in order to fasten one end of the reference shaft in a rotationally fixed manner in the region of a rotor blade root or in the region of a rotor blade tip. A rotationally fixed fastening of an outer end of the reference shaft in the rotor blade tip has the effect that twisting in the region of the rotor blade tip is transmitted via the rotationally rigid reference shaft to an inner end of the reference shaft. This inner end may for example be arranged at the rotor blade root or at an end of the leading edge web that is arranged in the vicinity of the rotor blade root. As a result, the twisting of the rotor blade tip can be measured at the inner end of the reference shaft, that is to say for example in the region of the rotor blade hub. However, it also comes into consideration to provide further measuring sensors, and thereby also to detect a twist distribution of the rotor blade.

Good installability of the measuring system is also provided, by the reference shaft being able for example to be pushed into the rotationally fixed shaft seat in the region of the blade tip, or the reference shaft together with the rotationally fixed shaft seat being able to be pushed into the rotor blade tip. The problem of a blade tip that is poorly accessible from the inside is at least reduced in this way. As a result, rotary sensors in the region of the poorly accessible rotor blade tip are also no longer necessary.

The rotor blade root consequently forms a fixed point for the reference shaft and for the twisting to be detected. The rotor blade itself twists from the blade root, since that is where the blade is fastened on a rotor hub. Consequently, a twisting is detected with reference to the blade root. The reference shaft forms a torsion-free extension of the blade root. The detection of a twisting in relation to the reference shaft is consequently a detection of the twisting in relation to the blade root.

However, the reference shaft is supported by position bearings along its length in such a way that it is substantially only loosely kept in position, with only transverse forces being passed on by the position bearings. Torsional forces however are not introduced into the reference shaft. Consequently, at these position bearings, the rotor blade can twist freely about the reference shaft. A twisting of the rotor blade tip with respect to the rotor blade root would bring about a rotational angle between the twisted rotor blade in the blade tip and the non-twisted reference shaft and would indicate a torsion angle at the blade tip.

Alternatively, it may be provided that the reference shaft is supported in a rotationally fixed manner in a region of the rotor blade root. A twisting of the rotor blade tip would then have the effect that it twists in relation to the reference shaft. For detecting the twisting of the blade tip, it would however also be necessary for the rotary sensor to be arranged in the region of the poorly accessible blade tip.

Specifically at one end or some other location of the reference shaft, the latter must be connected to the rotor blade in a rotationally fixed manner. This may for example also be in the middle. The measuring system can consequently be used for various types of rotor blades, for which there are different installation situations.

A development of the measuring system provides that the reference shaft is electrically non-conductive. This particularly achieves lightning protection, which prevents lightning from striking the reference shaft, or prevents a lightning strike from inducing a current in the reference shaft.

In one embodiment, the reference shaft is produced from a fiber composite material. A plastic reinforced with aramid fibers or carbon fibers is particularly envisaged for this. Such plastics have a high strength with at the same time low weight, and consequently allow a very lightweight reference shaft. In addition, such plastics have no or only a small positive or negative coefficient of thermal expansion, so that the reference shaft experiences little thermal expansion over a very great temperature range. The measurement of the rotary sensors is consequently temperature-independent. As a result, mechanical stresses can particularly also be avoided.

In a further configuration of the measuring system, the reference shaft is supported in an axially displaceable manner. This can take place by means of the position bearings already mentioned above. Consequently, expansions of the rotor blade on account of temperature changes or for other reasons do not influence the reference shaft. Such expansions of the rotor blade, which can also be caused by a bending of the rotor blade, only lead to a relative axial displacement between the rotor blade and the reference shaft.

The rotary sensor may particularly be formed by a marker element fastened on the reference shaft and a pickup fastened alongside it on the rotor blade. A twisting of the rotor blade in the region of such a sensor then leads to a twisting of the marker element in relation to the pickup. The marker element may also be referred to as a transducer. The pickup can detect this relative twisting and determine and output the reference angle or a variable corresponding thereto. The marker element may for example be formed as an annular disk with a barcode, or simply have a reference marking that allows a twisting to be detected. Depending on the characteristics of the reference shaft and the requirement for accuracy, the marker element may also be no longer necessary and the pickup may detect a relative movement of the reference shaft directly.

With such a rotary sensor, the position of the two portions in relation to one another, that is to say the torsion angle, can be detected very accurately. Purely bending of the reference shaft does not in this case influence the rotational angular position of the two portions in relation to one another. Also, a slight displacement along the torsion axis, for example due to thermal expansion, does not influence the rotational angular position of the two portions in relation to one another. Only a torsion of the rotor blade causes a twisting of the two portions in relation to one another, from which the torsion angle of the rotor blade can be determined. The torsion angle determination is consequently independent of other influences.

In a further embodiment of the measuring system, a number of rotary sensors for detecting a twisting of the rotor blade are arranged at a number of positions along the reference shaft. This allows the torsion angle to be determined at a number of positions along the radius of the rotor. A number of rotary sensors along the reference shaft make it possible to detect regions of the rotor blade that twist more than other regions. A greater torsion may occur because of a lower stiffness of the rotor blade, for example in the blade tip. Any overloading of individual regions of the rotor blade can in this way also be detected.

A further embodiment of the measuring system is characterized in that the reference shaft is supported on the number of rotary sensors along the longitudinal direction of the blade, so that the rotor blade can rotate about the reference shaft. The rotary sensors therefore form at the same time the support for the reference shaft along the longitudinal direction of the rotor blade. This may particularly concern a rotor sensor that has a marker element and a pickup, the reference shaft being supported in the pickup of the rotary sensor. Consequently, additional bearings, and therefore additional weight and/or additional costs, can be avoided. However, the rotary sensors are intended at the same time to allow a free rotation of the rotor blade about the reference shaft. In a further configuration of the measuring system, the supporting means are adhesively attached or clamped to the leading edge web. For the adhesive attachment, each supporting means may particularly have a flat adhering surface, which is provided with an adhesive, or can be provided with an adhesive. As a result, simple and robust fastening is possible. Clamping of the supporting means is envisaged in particular in those regions of the rotor blade that are not accessible or poorly accessible for the mounting of the measuring system. For this, the supporting means can for example be pushed onto the web and are adapted to a geometry of the leading edge web onto which they are pushed. By means of an auxiliary means, the supporting means is then brought into the inaccessible region and clamped at the intended position. In this way, retrofitting of the measuring system in rotor blades that are already in use is possible. The supporting means for arranging the reference shaft on the leading edge web can be adhesively attached at locations that are accessible in the rotor blade. A further advantageous configuration of the measuring system envisages that the at least one rotary sensor is formed as an optical rotary sensor. Particularly, an optical scanning of the marker element by the pickup is proposed. Furthermore, it also comes into consideration that the rotary sensor operates exclusively optically and detected values or positions of a torsion angle are also transmitted optically, particularly via optical waveguides, to an evaluation unit, which may be arranged in the blade root or the rotor hub. By the use of such optical rotary sensors, protection from or immunity to a lightning strike can likewise be achieved.

Another configuration of the measuring system is characterized in that the reference shaft is formed by a number of shaft segments. Such a configuration is very advantageous for installing or retrofitting the measuring system in very long rotor blades, which may have a length of over 60 meters, since it allows the shaft to be transported to the installation site in a number of individual parts and put together to the intended length on site. The shaft segments may for example have ends that are adapted to one another in order to be inserted into one another. In this case, the adapted ends are formed in such a way that a rotationally rigid plug-in connection is produced when they are inserted into one another.

In addition, provided is a method for determining a torsion of a rotor blade. It operates in such a way that a torsion of the rotor blade about a reference shaft arranged in the rotor blade in the longitudinal direction of the blade is detected, the reference shaft is supported in the rotor blade in such a way that the rotor blade can twist freely about the reference shaft, so that the reference shaft does not twist when there is twisting of the rotor blade, a twisting is detected by at least one rotary sensor arranged on the reference shaft for detecting a twisting of the rotor blade about the reference shaft in the region of the rotary sensor, and a rotary angle describing the twisting of the rotor blade in relation to the reference shaft, or some other corresponding variable, is output by means of the rotary sensor.

With particular preference, the method uses a measuring system according to an embodiment described above. Furthermore or alternatively, the method operates as described above in conjunction with at least one embodiment of a measuring system.

Preferably, the rotational angle or the twisting of the rotor blade is detected at a number of positions distributed in the longitudinal direction of the blade. Consequently, the torsion angle can be determined at a number of positions of the rotor blade and this can be used to obtain information about the torsion behavior in different regions of the rotor blade.

A further embodiment of the method provides that the rotational angle and/or the twisting of the rotor blade is detected continuously over time. For example, for this, data of the rotary sensors are recorded and, particularly, further processed by a process computer. Consequently, the torsion angle can likewise be determined continuously over time and used for controlling the operational control of the wind power installation. The rotational angle thus detected or the twisting thus detected of the rotor blade can be fed to a control system of the wind power installation for further processing.

Furthermore, provided is a rotor blade of a wind power installation. The rotor blade comprises a rotor blade root for fastening the rotor blade on a rotor hub, a rotor blade tip arranged on a side of the rotor blade that is facing away from the rotor blade root, a reference shaft arranged in the rotor blade in the longitudinal direction of the blade, at least one support for the reference shaft, for freely bearing the reference shaft in the rotor blade, so that the rotor blade can twist freely about the reference shaft, so that the reference shaft does not twist when there is twisting of the rotor blade, and at least one rotary sensor arranged on the reference shaft for detecting a twisting of the rotor blade about the reference shaft in the region of the rotary sensor, the rotary sensor outputting a rotational angle describing the twisting of the rotor blade in relation to the reference shaft, or some other corresponding variable.

Such a rotor shaft particularly comprises a measuring system as described above according to at least one embodiment. This allows a torsion of the rotor blade to be detected in an easy way, in particular as already described above.

Such a rotor blade makes accurate determination of a torsion angle of the rotor blade possible. This allows conclusions to be drawn about the output and the operating state of the wind power installation. In particular, aerodynamic assumptions and simulations of the structural design of the rotor blade can also be validated, in particular with regard to the influence of the torsion angle on operating loads, the output or the noise generated.

Preferably, at least one leading edge web running from the rotor blade root in the direction of the rotor blade tip is provided, the reference shaft and at least one portion of the rotary sensor being arranged on the leading edge web. As a result, the measuring system can be formed in the rotor blade in an easy way, because the leading edge web runs substantially from the blade root to the blade tip, and consequently offers a good possibility for fastening or supporting the measuring system in the rotor blade. According to a further embodiment, it is proposed that the supporting of the reference shaft takes place between two webs, particularly between two webs that do not comprise the leading edge web, and takes place there on one of these webs. As a result, the measuring system can be mounted in the rotor blade during the production of the rotor blade, when mold halves of the rotor blade are still open. This also allows supporting of the reference shaft at the end on the blade tip side to be made easier.

One embodiment of the rotor blade provides that the rotor blade has in its blade tip a shaft seat for bearing the reference shaft in a rotationally fixed manner. Such a shaft seat in the rotor blade has the advantage that no additional means are necessary for fastening the reference shaft on the rotor blade in a rotationally fixed manner. A rotationally fixed support for the reference shaft is necessary, since a rotational angle of the rotor blade with respect to the reference shaft is to be detected.

A further embodiment of the rotor blade is characterized in that the reference shaft is clamped in a structural element of the rotor blade, particularly in an inner contour of the leading edge web, in a rotationally rigid manner by means of a fitting piece. As a result, rotationally rigid fastening can be achieved even in the poorly accessible rotor blade tip.

A leading edge web is particularly suitable for this. Such a leading edge web has an upper flange and a lower flange, which are arranged lying opposite one another and are connected by way of a middle web portion. This provides a region in addition to the middle web portion and the two flanges into which the fitting piece can be clamped. There is in this case a good and durable fastening particularly where an undercut region is obtained between the flanges, to be specific particularly as a result of the two flanges not running exactly plane-parallel. In this way, supporting means can also be fastened on the leading edge web. With the supporting means, it should particularly be noted that they do not have to take much weight with the reference shaft.

Particularly in inaccessible regions of the rotor shaft, the supporting means can be easily pushed to the intended position and clamped there, so that no additional means are necessary for arranging the supporting means, and as a result the reference shaft, on the leading edge web or some other structural part of the rotor blade.

A preferred alternative embodiment of the rotor blade is characterized in that the rotor blade has in its blade root a shaft seat for bearing the reference shaft in a rotationally fixed manner. The reference shaft can be supported in the blade root in a particularly securely rotationally fixed manner and such a support can also be inspected quite well. In the case of this embodiment, the reference shaft remains at rest and the rotor blade twists about the reference shaft. As a result, unlike in the case of fixing in the blade tip, the reference shaft is not turned about its own axis when there is torsion of the rotor blade.

A wind power installation with a rotor blade according to the invention is also proposed.

Finally, the present invention also proposes a method for mounting a measuring system according to one of the embodiments or configurations described above in a rotor blade of a wind power installation.

The method comprises the steps of fastening a fitting piece in a rotationally rigid manner on a blade tip portion of the reference shaft, pushing the reference shaft with the fitting piece out in front into an installation space in the blade tip of the rotor blade, along a structural element, particularly a leading edge web, pushing the supporting means onto the reference shaft and fastening the supporting means along the structural element or the leading edge web, arranging the at least one rotary sensor in the region of the reference shaft in the rotor blade. Here, the special nature of the rotationally rigid reference shaft is particularly used for the mounting, in that this reference shaft is pushed from a region of the rotor blade that can be reached by a person into the space in the vicinity of the blade tip that cannot be reached by a person, and is consequently difficult to access. At the same time, the existing structure of the rotor blade is used there for the fastening.

Preferably, some of the supporting means are fastened in a region that cannot be reached by a person in the vicinity of the blade tip by securely clamping on the structural element or in the leading edge web and some other of the supporting means are adhesively attached in a region that can be reached by a person on the structural element or the leading edge web. Also in this way, the existing situation in the rotor blade can be used. Particularly in the region that cannot be reached by a person, the leading edge web has a region that tapers toward the blade tip and is often undercut, which can be used for pushing some supporting means in there in such a way that they are clamped there. All that is needed for this is for the respective supporting means to be adapted to the known size and shape of the region in which the supporting means is to be fixed. In the region that can be reached by a person, in which the leading edge web is also greater, fastening can be performed by adhesive attachment. There is also sufficient space there for the adhesive attachment to be carried out properly.

The method also makes it possible for already existing wind power installations to be retrofitted with a measuring system according to the invention. In addition, such a measuring system can consequently also be repaired or refitted after a repair.

Also proposed according to the invention is a method for maintaining or repairing a measuring system arranged in a rotor blade for determining a torsion of the rotor blade, and the measuring system comprises

a reference shaft (12), arranged in the rotor blade in the longitudinal direction of the blade,

at least one support for the reference shaft (12), for freely bearing the reference shaft (12) in the rotor blade, so that the rotor blade can twist freely about the reference shaft (12), so that the reference shaft (12) does not twist when there is twisting of the rotor blade, and

at least one rotary sensor (20), arranged on the reference shaft, for detecting a twisting of the rotor blade about the reference shaft (12) in the region of the rotary sensor (20), the rotary sensor (20) outputting a rotational angle describing the twisting of the rotor blade in relation to the rotor shaft (12), or some other corresponding variable, comprising the steps of:
removing the rotor shaft or part of it from at least one of the supports,
taking out this at least one support and/or the at least one rotary sensor,
inspecting the support taken out or the rotary sensor taken out and
refitting the support or the rotary sensor, or a corresponding replacement part,
refitting the reference shaft or the part of it that was removed.

This allows maintenance or repair of the measuring system to be carried out in an easy way. By performing the successive steps, the elements can be individually removed and inspected and if need be repaired or replaced.

### BRIEF DESCRIPTION OF THE SEVERAL VIEWS OF THE DRAWINGS

The invention is described by way of example below on the basis of embodiments with reference to the accompanying figures.

FIG. 1 perspectively shows a wind power installation in a schematic representation.

FIG. 2 shows a schematic representation of an embodiment of a measuring system according to the invention.

FIG. 3 schematically shows a supporting means given by way of example.

FIG. 4 schematically shows a supporting means arranged in a rotor blade.

FIG. 5 shows a leading edge web in a perspective representation.

FIG. 6 shows an enlarged detail of a leading edge web from FIG. 5.

FIG. 7 shows a further embodiment of a bearing means.

### DETAILED DESCRIPTION

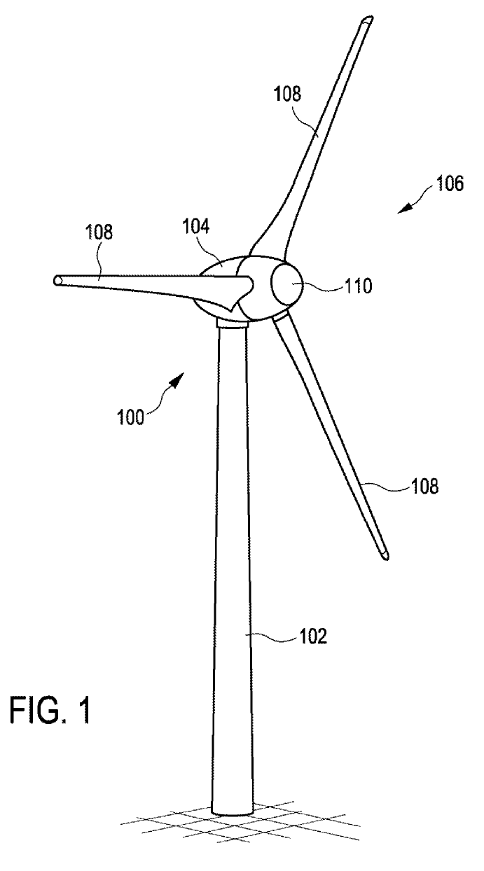

FIG. 1 shows a wind power installation 100 according to the invention with a tower 102 and a nacelle 104. Arranged on the nacelle 104 is a rotor 106 with three rotor blades 108 according to the invention and a spinner 110. During operation, the rotor 106 is set in a rotary motion by the wind, and thereby drives a generator in the nacelle 104. During the rotation, the rotor blades 108 may twist. For detecting and determining the torsion of the rotor blades 108, a measuring system is mounted in the rotor blades 108.

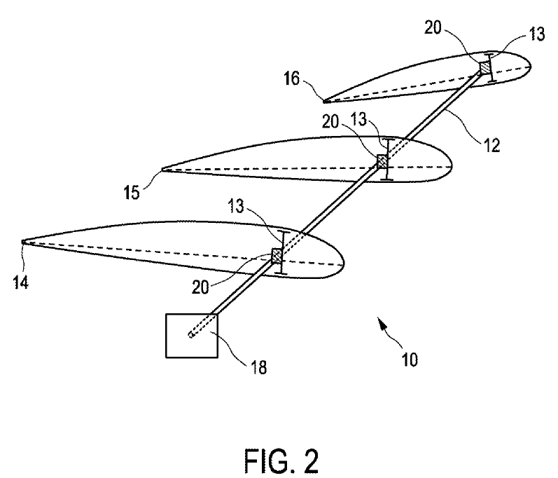

In FIG. 2, the components of the measuring system 10 are schematically represented. The measuring system 10 comprises a reference shaft 12. The reference shaft 12 is arranged in a rotor blade, on a leading edge web 13. The reference shaft 12 is preferably formed as a hollow shaft, so that a low weight is achieved, with at the same time a great stiffness of the reference shaft 12. The reference shaft 12 has an outer diameter of approximately 25 millimeters and an inner diameter of approximately 21 millimeters.

For a better overview, only three schematic profile sections 14, 15, 16 of the rotor blade are shown, the profile section 14 schematically representing a profile section in the region of a rotor blade root, the profile section 15 schematically representing a profile section in a region of the middle of the rotor blade and the profile section 16 schematically representing a profile section in a region of the rotor blade tip. For the sake of better overall clarity, particularly the profile 16, which is intended to represent such a profile in the vicinity of the blade tip, is shown enlarged. Also respectively indicated in the profile sections 14, 15, 16 by a dashed line is a profile chord, in order to represent a twisting of the profile section 16 with respect to the profile section 15 and the profile section 14. The profile section 15 is also twisted with respect to the profile section 14. The rotor blade is consequently twisted.

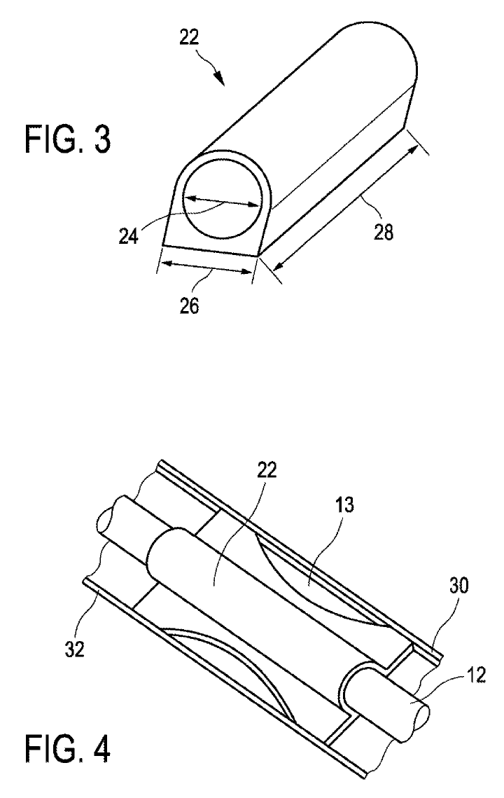

At one end, the reference shaft 12 is clamped in a shaft seat 18 in a rotationally fixed manner. The shaft seat 18 prevents a rotational movement of the reference shaft 12 about its longitudinal axis. In the exemplary embodiment shown, the reference shaft 12 is clamped in the region of the rotor blade root in a rotationally fixed manner. Provided along the reference shaft 12 are further bearings, which fasten the reference shaft 12 on the leading edge web 13. The further bearings are formed by supporting means 22 (see FIG. 3), which guide the reference shaft 12 but do not secure it in a rotationally rigid manner. Consequently, the rotor blade can twist about the reference shaft 12, without the reference shaft 12 twisting when there is twisting of the rotor blade.

Arranged along the reference shaft 12 are a number of rotary sensors 20. The rotary sensors 20 are merely represented schematically. The rotary sensors 20 may be fastened with a marker element on the reference shaft 12 and with a pickup on the leading edge web 13.

FIG. 2 also illustrates that the profile sections 14, 15, 16 are twisted to different degrees. With a number of rotary sensors 20 arranged along the reference shaft 12, consequently regions of the rotor blade with torsion angles of different magnitudes can also be determined.

FIG. 3 shows a schematic view of a supporting means 22 or a support. Such a supporting means 22 serves for arranging, guiding and bearing the reference shaft 22 on the leading edge web 13 or some other structural element of the rotor blade. The supporting means 22 are formed substantially as a tube. An inner diameter 24 of a preferred supporting means 22 is approximately 30 millimeters, and is consequently approximately 5 millimeters greater than the outer diameter of the preferred reference shaft 12. As a result, a free rotation of the rotor blade about the reference shaft 12 is possible with little to no friction. An outer diameter 26 of a preferred supporting means 22 is approximately 35 millimeters. A length 28 of a preferred supporting means 22 is approximately 250 millimeters.

FIG. 4 shows a supporting means 22, which is arranged on a leading edge web 13. The leading edge web 13 has an upper flange 30 and a lower flange 32. The supporting means 22 is clamped between the upper flange 30 and the lower flange 32 in order to arrange the reference shaft 12 on the leading edge web 13. To prevent a great flexural deflection of the reference shaft 12, supporting means 22 are provided approximately at a spacing of 2000 to 2500 millimeters along the leading edge web 13 for bearing the reference shaft 12.

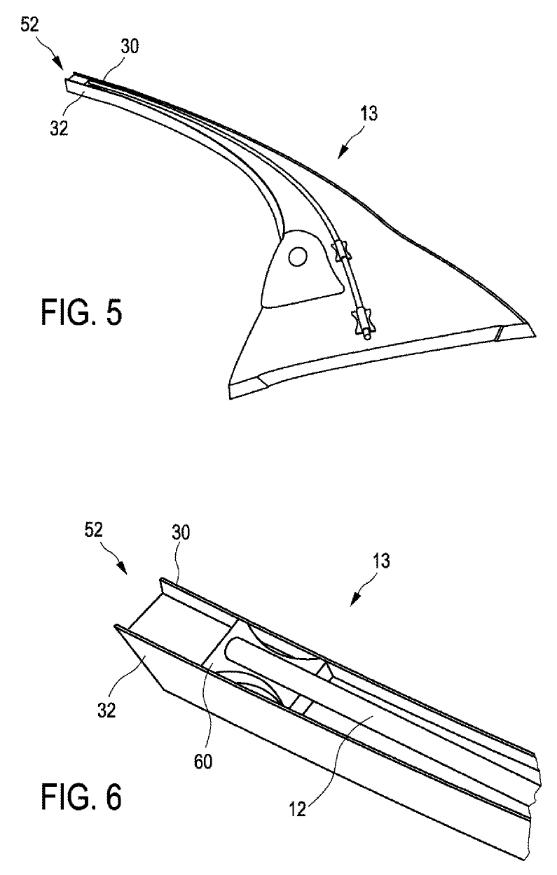

FIG. 5 shows a leading edge web 13 in a perspective representation from a blade root region 51 to a blade tip region 52. An upper flange 30 and a lower flange 32 particularly form only toward the blade tip region 52.

FIG. 6 shows an enlarged detail of the blade tip region 52 of the leading edge web 13 from FIG. 5. It can be seen there that a fitting piece 60 is clamped between the upper and lower flanges 30, 32 and receives the reference shaft 12 in a rotationally rigid manner. To this extent, this represents a different embodiment in comparison with FIG. 2. The fitting piece 60 therefore forms a shaft seat for the reference shaft 12. The fitting piece 60 is quite similar in its construction to the supporting means 22 from FIG. 4, the reference shaft 12 not reaching through the fitting piece 60 and being received in a rotationally rigid manner.

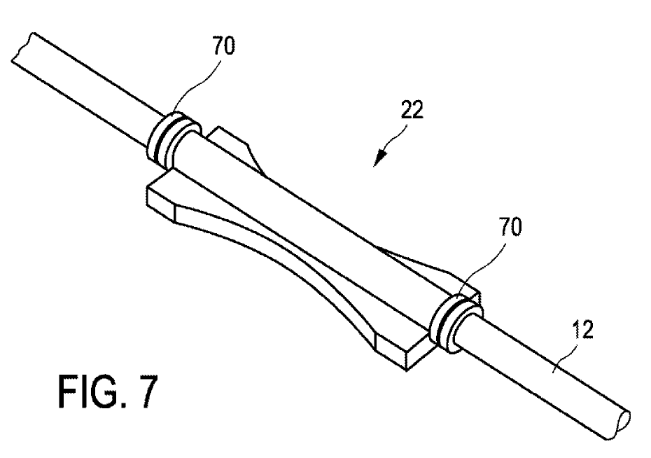

FIG. 7 shows a further embodiment of a supporting means 22. In this case, additionally arranged on the reference shaft 12 are clamping parts 70, which can absorb tensile and shearing forces of the reference shaft 12, which is formed as a hollow shaft. The clamping parts 70 are intended to prevent the reference shaft 12 from slipping out. The clamping parts should as far as possible be installed in such a way that contact of the clamping parts 70 with the support is avoided. In order in the event that contact does in fact occur to keep the friction as little as possible, it is proposed to provide a ball-bearing support between the clamping part 70 and the supporting means 22, in order in this way to avoid a torsion of the reference shaft.

Otherwise, for simplicity, the same reference signs may be used for the embodiments shown for elements that are similar but not necessarily identical.

For mounting the measuring system 10, the reference shaft 12 is pushed in the direction of the blade tip on the leading edge web 13. For this, the reference shaft 12 is preferably formed by a number of segments, which are individually connected to one another one after the other. At the end of the reference shaft 12 that is arranged in the region of the blade tip, the fitting piece 60 is fixedly mounted. The fastening element 22 is pushed in along the leading edge web until it is clamped between the upper flange 30 and the lower flange 32. The fastening element 22 is therefore fastened on the leading edge web 13 in an interlocking and frictionally engaging manner. In the case of this embodiment, the reference shaft 12 is therefore mounted in the region of the blade tip in a rotationally fixed manner.

Alternatively, it is however provided that, with a rotationally fixed support for the reference shaft 12 in the blade root, the fitting piece 60 only provides a final supporting of the reference shaft 12 in the blade tip, but allows a relative turning of the reference shaft. In this case, the fitting piece 60 is formed in such a way that the fitting piece 60 turns about the reference shaft 12 when there is torsion of the rotor blade.

Once the reference shaft 12 is mounted, the further supporting means 22 for bearing the reference shaft 12 are pushed on one after the other and, with the aid of an auxiliary tube, are brought to the prescribed setpoint position and pushed firmly into place. Clamping of the supporting means 22 takes place in regions of the rotor blade that are not accessible. In accessible regions, the supporting means 22 are adhesively attached. On the last segment of the reference shaft 12, a supporting element 22 as shown in FIG. 7 for absorbing the tensile forces and shearing forces of the reference shaft 12 may be provided or adhesively attached.

At prescribed positions, a corresponding rotary sensor 20 is respectively provided. It may be sufficient to provide a rotary sensor 20 only at the opposite end of the rotationally fixed support for the reference shaft 12.

The fixed restraint of the reference shaft 12 at one end of the leading edge web 13 has the effect that the torsion angles that are obtained along the radius of the rotor blade during the operation of the wind power installation are transmitted directly to the rotary sensors 20 along the leading edge web. Such a measuring system is unsusceptible to simultaneous occurrence of torsion and bending of the rotor blade, since exclusively twisting is detected by the rotary sensors 20. Since the supporting means 22 do not clamp the reference shaft in a fixed manner, the measuring system is also unsusceptible to different thermal expansions of the rotor blade and the reference shaft 12. Since the system is permanently integrated in the rotor blade, the torsion angle can be determined at any point in time during the operation of the wind power installation. Consequently, operating states of the installation can be monitored and simulation models that were used for designing the rotor blade and/or the wind power installation can be subsequently checked and thereby improved. As a result, the torsion angle can be used for controlling the operational control of the wind power installation.

It is also advantageous that, from the knowledge of the torsion angle, an operating state of the wind power installation can be derived, which is proposed according to one embodiment according to the invention. In addition, with the aid of the torsion angle, control of the wind power installation can be optimized with regard to operating loads. The torsion angle may also serve as a reference for the output delivered by the wind power installation and the noise emitted by the rotor blades.

1. A measuring system configured to determine a torsion of a rotor blade, the measuring system comprising:
a reference shaft configured to be arranged in the rotor blade in a longitudinal direction of the blade;
at least one support for the reference shaft, the at least one support being configured to hold the reference shaft in the rotor blade so that the rotor blade is free to twist about the reference shaft and the reference shaft does not twist when the rotor blade twists;
at least one rotary sensor arranged on the reference shaft, the at least one rotary sensor being configured to detect a twisting of the rotor blade about the reference shaft in a region of the at least one rotary sensor, the at least one rotary sensor being configured to output a signal indicative of a rotational angle describing twisting of the rotor blade in relation to the rotor shaft.

2. The measuring system as claimed in claim 1, wherein the reference shaft is a hollow shaft.

3. The measuring system as claimed in claim 1, further comprising supporting means configured to arrange the reference shaft along a leading edge web of the rotor blade.

4. The measuring system as claimed in claim 1, further comprising a rotationally fixed shaft seat configured to fasten one end of the reference shaft in a rotationally fixed manner in a region of a rotor blade tip.

5. The measuring system as claimed in claim 1, wherein the reference shaft is made of an electrically non-conductive material.

6. The measuring system as claimed in claim 1, wherein the reference shaft is produced from a composite fiber material.

7. The measuring system as claimed in claim 1, wherein the reference shaft is arranged in an axially displaceable manner.

8. The measuring system as claimed in claim 1, wherein the rotary sensor has a marker element, configured to be coupled to the reference shaft, and a pickup configured to be coupled to the leading edge web of the rotor blade the pickup being configured to detect a twisting of the marker element in relation to the pickup to detect a twisting of the rotor blade in relation to the reference shaft at this location.

9. The measuring system as claimed in claim 1, wherein a number of rotary sensors for detecting a twisting of the rotor blade are arranged at a number of positions along the reference shaft.

10. The measuring system as claimed in claim 8, wherein the at least one rotary sensor is a plurality of rotary sensors, each of the plurality of rotor sensors being configured to hold the reference shaft along the longitudinal direction of the blade.

11. The measuring system as claimed in claim 3, wherein the supporting means are configured to be adhesively attached or clamped on the leading edge web.

12. The measuring system as claimed in claim 1, wherein the at least one rotary sensor is an optical rotary sensor.

13. The measuring system as claimed in claim 1, wherein the reference shaft comprises a plurality of shaft segments.

14. A method comprising:
detecting a torsion of a rotor blade about a reference shaft, wherein the reference shaft is arranged in the rotor blade in a longitudinal direction of the blade, wherein the reference shaft is supported in the rotor blade in such a way that the rotor blade can twist freely about the reference shaft and the reference shaft does not twist when the rotor blade twists,
detecting a twisting of the rotor blade by at least one rotary sensor arranged on the reference shaft, and
outputting a signal indicative of a rotary angle describing the twisting of the rotor blade in relation to the reference shaft.

15. (canceled)

16. The method as claimed in claim 14, wherein detecting the twisting of the rotor blade by at least one rotary sensor the rotary comprises detecting a twisting of the rotor blade by a plurality of rotary sensors arranged at a plurality of positions distributed in the longitudinal direction of the blade.

17. The method as claimed in claim 14, wherein detecting the twisting of the rotor blade comprises detecting the twisting of the rotor blade continuously over time.

18. A rotor blade of a wind power installation the rotor blade comprising:
a rotor blade root configured to fasten the rotor blade to a rotor hub;
a rotor blade tip arranged on a side of the rotor blade that is facing away from the rotor blade root;
a reference shaft arranged in the rotor blade in a longitudinal direction of the blade;
at least one support for the reference shaft, configured to couple the reference shaft in the rotor blade so that the rotor blade freely twists about the reference shaft and so that the reference shaft does not twist as the rotor blade twists; and
at least one rotary sensor arranged on the reference shaft, the at least one rotary sensor being configured to detect a twisting of the rotor blade about the reference shaft in a region of the at least one rotary sensor, the at least one rotary sensor being configured to output a signal indicative of a rotational angle describing the twisting of the rotor blade in relation to the reference shaft.

19. The rotor blade as claimed in claim 18, comprising a leading edge web extending from the rotor blade root to the rotor blade tip, wherein the reference shaft and at least a portion of the at least one rotary sensor are arranged on the leading edge web.

20. (canceled)

21. The rotor blade as claimed in claim 18, wherein the rotor blade tip has a shaft seat for bearing the reference shaft in a rotationally fixed manner.

22. The rotor blade as claimed in claim 18, wherein the reference shaft is clamped in a structural element of the rotor blade in a rotationally rigid manner.

23. The rotor blade as claimed in claim 18, wherein the rotor blade root has a shaft seat for holding the reference shaft in a rotationally fixed manner.

24. A method for mounting a measuring system as claimed in claim 3 in a rotor blade of a wind power installation, the method comprising:
fastening a fitting piece in a rotationally rigid manner on a blade tip portion of the reference shaft;
pushing the reference shaft with the fitting piece out in front into an installation space of a blade tip of the rotor blade, along a leading edge web;
pushing the supporting means onto the reference shaft and fastening the supporting means along the leading edge web;
arranging the at least one rotary sensor in a region of the reference shaft in the rotor blade.

25. The method as claimed in claim 24, wherein:
first set of the supporting means are fastened in a region that cannot be reached by a person in a vicinity of the blade tip by securely clamping in the leading edge web, and
second set of the supporting means are adhesively attached in a region that can be reached by a person on the structural element or the leading edge web.

26. A method comprising: for
maintaining or repairing a measuring system arranged in a rotor blade, wherein the measuring system is configured to determine a torsion of the rotor blade, wherein the measuring system comprises:
a reference shaft arranged in the rotor blade in the longitudinal direction of the blade,
at least one support for the reference shaft for freely bearing the reference shaft in the rotor blade, so that the rotor blade can twist freely about the reference shaft and so that the reference shaft does not twist when the rotor blade twists, and
at least one rotary sensor arranged on the reference shaft and for detecting a twisting of the rotor blade about the reference shaft in the region of the rotary sensor, the rotary sensor outputting a rotational angle describing the twisting of the rotor blade in relation to the rotor shaft,
wherein maintaining or repairing comprises:
removing at least a portion of the reference shaft from the at least one of the supports support,
removing at least one of: the at least one support or the at least one rotary sensor,
inspecting at least one of: the at least one support or the at least one sensor, and
refitting at least one of: the at least one support, the at least one rotary sensor, or the portion of the reference shaft.

27. (canceled)

28. (canceled)
